(19) United States
(12) Patent Application Publication
(10) Pub. No.: US 2004/0020342 A1
(43) Pub. Date: Feb. 5, 2004

(54) Fence protection arrangement for a slide miter saw

(76) Inventor: Brian P. Wattenbach, Columbia, MD (US)

Correspondence Address: Adan Ayala, Esq., Black & Decker Inc., 701 E. Joppa Road, TW-199, Towson, MD, 21286, US

(21) Appl. No.: 10/211,735

(22) Filed: Aug. 2, 2002

(51) Int. Cl. B26D 1/14; B27B 5/00; B27B 5/34; B23D 19/00

(52) U.S. Cl. 83/860; 83/581; 83/477.1

(57) ABSTRACT

A miter saw includes a base, a fence assembly attached to the base, a table rotatably attached to the base, a support housing connected to the table, at least one rail slidably connected to the support housing, a saw assembly pivotally attached to the at least one rail and movable between a front position and a rear position, the saw assembly including a trunnion disposed on the at least one rail, a pivot arm pivotally attached to the trunnion, an upper blade guard connected to the pivot arm, a motor attached to the upper blade guard, and a blade driven by the motor, wherein at least one of the trunnion, pivot arm, upper blade guard, and motor is disposed behind the blade and contacts the fence assembly when the saw assembly is beveled and moved towards the rear position.

### FIELD OF THE INVENTION

This invention relates generally to slide miter saws and specifically to fence protection arrangements for slide miter saws.

### BACKGROUND OF THE INVENTION

Slide miter saws are well known in the art as they provide extended cutting range over non-sliding miter saws. Like non-sliding miter saws, the slide miter saws have a base, a rotatable table attached to the base, a saw assembly including a motor and a blade driven by the motor, where the saw assembly is pivoted downwardly for cutting a workpiece disposed on the base and table, and a sliding fence assembly connected to the base for supporting a workpiece. However, slide miter saws enable the user to move the saw assembly horizontally along the table.

Most slide miter saws accomplish this by connecting the saw assembly to at least one rail, which is slidably attached to a support housing connected to the table (see, e.g., U.S. Pat. No. 6,067,885). With such arrangement, the user would pull the saw assembly forwardly, move the saw assembly downwardly, then push the saw assembly rearwardly for cutting the workpiece.

In typical slide miter saws, the user would pull the saw assembly forwardly, bevel the saw assembly, move the saw assembly downwardly, then push the saw assembly rearwardly for cutting the workpiece. However, if the user has not adjusted the sliding fence assembly, the saw assembly may cut through the fence. Thus, it is desirable to provide a fence protection arrangement.

### SUMMARY OF THE INVENTION

In accordance with the present invention, an improved miter saw is employed. The miter saw includes a base, a fence assembly attached to the base, a table rotatably attached to the base, a support housing connected to the table, at least one rail slidably connected to the support housing, a saw assembly pivotally attached to the at least one rail and movable between a front position and a rear position, the saw assembly comprising a trunnion disposed on the at least one rail, a pivot arm pivotally attached to the trunnion, an upper blade guard connected to the pivot arm, a motor attached to the upper blade guard, and a blade driven by the motor, wherein at least one of the trunnion, pivot arm, upper blade guard, and motor is disposed behind the blade and contacts the fence assembly when the saw assembly is beveled and moved towards the rear position.

Additional features and benefits of the present invention are described, and will be apparent from, the accompanying drawings and the detailed description below.

### BRIEF DESCRIPTION OF THE DRAWINGS

The accompanying drawings illustrate preferred embodiments of the invention according to the practical application of the principles thereof, and in which:

FIG. 1 is a side view of a slide miter saw according to the invention; and

FIG. 2 is a partial front view of the embodiment of FIG. 1.

### DETAILED DESCRIPTION

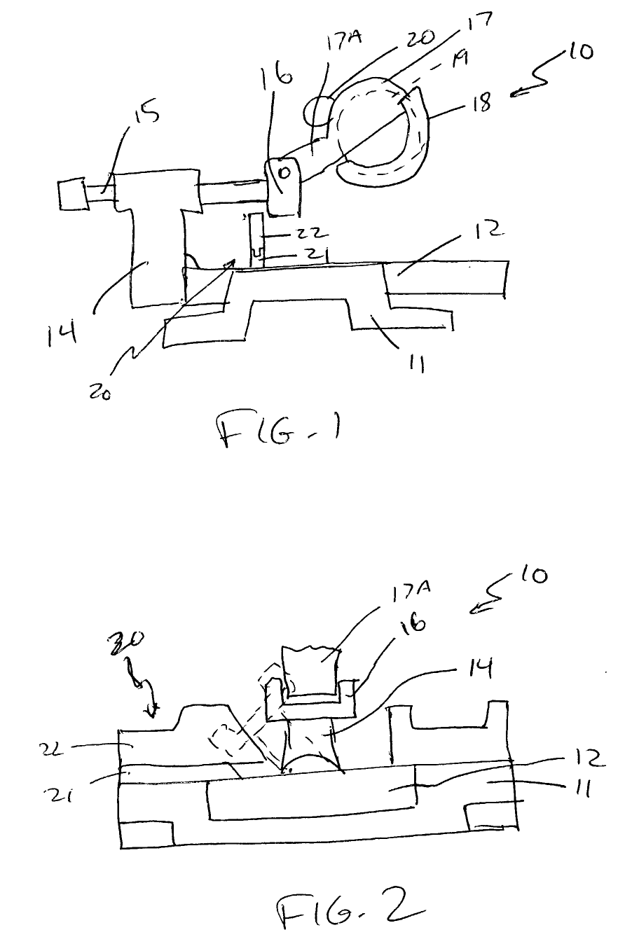

The invention is now described with reference to the accompanying figures, wherein like numerals designate like parts. Referring to FIGS. 1-2, a slide miter saw 10 preferably has a base 11, a table 12 rotatably connected to the base 11, a support housing 14 pivotally connected to table 12, at least one (and preferably two) rail(s) 15 slidably connected to the support housing 14, and a saw assembly which comprises a trunnion 16 attached to one end of the rail(s) 15, a pivot arm 17A pivotably attached to trunnion 16, a motor 20, a blade 19 driven by the motor, an upper blade guard 17 for covering an upper part of blade 19, and a lower blade 18 pivotally attached to the upper blade guard 17 for covering a lower part of blade 19. Preferably the motor 20 is attached to the upper blade guard 17. These elements are well known in the art. Persons skilled in the art are referred to U.S. Pat. No. 6,067,885, which is wholly incorporated by reference herein.

The slide miter saw 10 may also have a movable fence assembly 20 attached to the base 11. Movable fence assembly 20 preferably extends laterally across table 12, against which a workpiece can be positioned and supported for performing a cutting operation thereon. Movable fence assembly 20 may include a fixed fence 21 attached to base 11, and a movable fence 22 connected to the fixed fence 21. Preferably, movable fence 22 is slidably attached to fixed fence 21. Persons skilled in the art are referred to U.S. Pat. Nos. 5,297,463 and 5,943,931, which are wholly incorporated by reference herein.

It is preferable to design miter saw 10 so that at least one component of the saw assembly located behind blade 19, so that, when the saw assembly is beveled, such component would contact the movable fence 22 before blade 19, preventing blade 19 from cutting movable fence 22.

Preferably, such component will be trunnion 16. As shown in FIG. 2, when the saw assembly is beveled, trunnion 16 would contact movable fence 22 as the saw assembly is moved rearwardly, preventing contact between blade 19 and movable fence 22. To complete the cut, the user would need to move movable fence 22 outwardly.

Persons skilled in the art will recognize that trunnion 16 is preferably disposed at a position lower than the highest point of movable fence 22, when the saw assembly is not beveled. In addition, a plane containing blade 19 preferably contacts trunnion 16 (or any other saw assembly component used to contact movable fence 22).

While the miter saw of FIGS. 1-2 shows a miter saw 10 with one movable fence assembly 20, persons skilled in the art should recognize that the miter saw 10 can be provided with two movable fence assemblies 20 disposed on both sides of base 11. Persons skilled in the art will also recognize that it is preferable to design the above-described arrangement so that blade 19 cannot cut either movable fence assembly 20.

Persons skilled in the art may recognize other additions or alternatives to the means disclosed herein. However, all these additions and/or alterations are considered to be equivalents of the present invention.

What is claimed is:

1. A miter saw comprising:
a base;
a fence assembly attached to the base;
a table rotatably attached to the fence;
a support housing connected to the table;
at least one rail slidably connected to the support housing; and
a saw assembly pivotally attached to the at least one rail and movable between a front position and a rear position, the saw assembly comprising a trunnion disposed on the at least one rail, a pivot arm pivotally attached to the trunnion, an upper blade guard connected to the pivot arm, a motor attached to the upper blade guard, and a blade driven by the motor;
wherein at least one of the trunnion, pivot arm, upper blade guard, and motor is disposed behind the blade and contacts the fence assembly when the saw assembly is beveled and moved towards the rear position.

2. The miter saw of claim 1, wherein the blade is disposed in a plane which intersects the at least one of the trunnion, pivot arm, upper blade guard, and motor.

3. The miter saw of claim 1, wherein the trunnion is below a highest point of the fence assembly.

4. The miter saw of claim 1, wherein the fence assembly comprises a fixed fence attached to the base and a movable fence movably connected to the fixed fence.

5. The miter saw of claim 4, wherein the movable fence is slidably connected to the fixed fence.

6. The miter saw of claim 4, wherein the trunnion is below a highest point of the movable fence.

7. A method of using a miter saw, comprising the steps of:
providing a miter saw with a base, a fence assembly attached to the base, a table rotatably attached to the fence, a support housing connected to the table, at least one rail slidably connected to the support housing, and a saw assembly pivotally attached to the at least one rail and movable between a front position and a rear position, the saw assembly comprising a trunnion disposed on the at least one rail, a pivot arm pivotally attached to the trunnion, an upper blade guard connected to the pivot arm, a motor attached to the upper blade guard, and a blade driven by the motor, wherein at least one of the trunnion, pivot arm, upper blade guard, and motor is disposed behind the blade;
beveling the saw assembly;
moving the saw assembly towards the rear position;
contacting the fence assembly with the at least one of the trunnion, pivot arm, upper blade guard, and motor.

8. The method of claim 7, wherein the fence assembly has a movable portion, and movable portion is contacted by the at least one of the trunnion, pivot arm, upper blade guard, and motor in the contacting step.

9. The method of claim 8, further comprising the step of moving the movable portion.
